(19) United States
(12) Patent Application Publication
(10) Pub. No.: US 2011/0002466 A1
(43) Pub. Date: Jan. 6, 2011

(54) CLIENT APPARATUS FOR SUPPORTING MOBILITY AND SECURITY BETWEEN HETEROGENEOUS NETWORKS USING MOBIKE PROTOCOL

(76) Inventors: Dong-Jin Kwak, Seoul (KR); Woo-Jin Choi, Seoul (KR); Seong-Choon Lee, Seoul (KR); Hyung-Keun Ryu, Seoul (KR)

Correspondence Address: IP & T GROUP LLP, 7700 Little River Turnpike, Suite 207, Annandale, VA, 22003, US

(21) Appl. No.: 12/820,998

(22) Filed: Jun. 22, 2010

(30) Foreign Application Priority Data
Jul. 6, 2009 (KR) 10-2009-0061244

(51) Int. Cl. H04W 12/08; G06F 21/20; H04W 36/00

(52) U.S. Cl. 380/272; 380/270; 726/6; 370/331; 726/3

(57) ABSTRACT

A client apparatus includes a wireless network access unit configured to access wireless networks, a packet analysis unit configured to analyze uplink and downlink data packets, a security tunnel processor configured to establish a mobile security tunnel and to maintain the established mobile security tunnel when handover is performed in heterogeneous networks, a wireless network controller configured to control a wireless network accessing process and a connection releasing process of the wireless network access unit, a mobile security tunnel controller configured to perform a MOBIKE protocol and to control a process of establishing and maintaining a mobile security tunnel of the security tunnel processor, and a wireless network connection manager configured to request the mobile security tunnel controller to perform a MOBIKE protocol by managing MOBIKE information and to control handover by setting up and managing a wireless network access policy.

### CROSS-REFERENCE(S) TO RELATED APPLICATIONS

The present application claims priority of Korean Patent Application No(s). 10-2009-0061244, filed on Jul. 6, 2009, which is incorporated herein by reference in its entirety.

### BACKGROUND OF THE INVENTION

1. Field of the Invention

Exemplary embodiments of the present invention relate to a client apparatus for supporting mobility and security between heterogeneous networks; and, more particularly, to a client apparatus for supporting mobility and security between heterogeneous networks using MOBIKE, which enables a user to have a wireless Internet service with service continuity during moving between heterogeneous networks using one integrated wireless access client apparatus and with security using an IP security protocol at the same time. Here, MOBIKE is an IKEv2 Mobility and Multihoming protocol (Request for Comments (RFC): 4555). The heterogeneous networks include a Wireless Broadband (WiBro) system, a WiFi system, and a 3rd generation High speed downlink packet access (3G HSDPA) system.

Hereinafter, a client apparatus for supporting mobility and security between heterogeneous networks in accordance with an embodiment of the present invention will be described based on a wireless access network such as a WiBro system, a WiFi system, and a 3G HSDPA system. However, the client apparatus for supporting mobility and security between heterogeneous networks in accordance with an embodiment of the present invention is not limited thereto.

That is, a client apparatus for supporting mobility and security between heterogeneous networks using a MOBIKE protocol in accordance with an embodiment of the present invention may access various wireless access networks including code division multiple access (CDMA), wide-CDMA (WCDMA), high speed downlink packet access (HSDPA), and high speed uplink packet access (HSUPA) based wireless networks (for example, mobile communication network), a complex Pi-sigma network (CPSN) (for example, a satellite communication network), an IEEE 802.11x based wireless communication network (for example, a wireless LAN communication network), an IEEE 802.16x based wireless communication network (for example, mobile Internet), and an orthogonal frequency division multiplexing access (OFDMA) based 3^{rd} generation partnership project long term evolution (3GPP LTE) based wireless communication network.

2. Description of Related Art

Various technologies for accessing wireless networks such as a WiBro system, a 3G HSDPA system, and a WiFi system have been introduced. These wireless networks coexist in a wireless communication environment. In such a wireless communication environment, a user has been provided with selective wireless Internet services according to a user preference and an available wireless network. These wireless Internet services are limited from aspects of service coverage and bandwidth.

The 3G HSDPA system has an advantage of a wide service coverage area. However, the 3G HSDPA system has a disadvantage of a narrow service bandwidth which is too narrow to provide various wireless Internet services. It may require additional base station installation. The WiBro system advantageously provides a user with a service bandwidth wider than that of a 3G HSDPA system. Accordingly, the WiBro system can provide various wireless Internet services to a user. However, the WiBro system has a disadvantage of a narrow service coverage area. The WiFi system also advantageously provides each user with a wide service bandwidth. Thus, the WiBro system can provide various wireless Internet services. However, the WiFi system has a disadvantage of a narrow service coverage area. Thus, the WiFi system has been frequently used for providing a service where a user is stationary due to the narrow service coverage area.

Internet service providers (ISP) have been individually developed an access client according to each wireless access network. Since it is an initial stage for developing a simple integrated client for accessing heterogeneous networks, mobility and security between heterogeneous networks have not been considered.

Accordingly, a currently available client for accessing wireless networks does not provide one integrated media modem in various wireless network environments. Further, such a typical client does not provide mobility and security between heterogeneous networks by automatically selecting a wireless access network according to a user preference and a policy. Therefore, the typical client is not appropriate for a wireless Internet user who frequently moves between heterogeneous networks.

In order to have a wireless Internet service, a user has been required to select a wireless access network and to access the selected wireless access network according to a target service and available wireless network environments. Further, it is expected that an integrated billing system will be introduced. Since a different billing system has been applied to each wireless Internet service, a user will be required to subscribe each one of wireless network access services to receive a desired wireless network service unless the user has a private network. Since a seamless mobility service has not been provided for maintaining a session during moving between heterogeneous networks, a user is also required to manually re-access a desired wireless network when the user moves between heterogeneous networks. Due to security problems such as interception and wiretapping, a wireless security function has been provided to each wireless access network. However, an integrated security function is not provided for guaranteeing security in various wireless access networks.

As described above, the related technologies have following problems. In order to have a service, a user is required to select a wireless access network suitable to a desired service and a surrounding environment and to access the selected wireless access network. Further, the user is required to subscribe each wireless network access service to receive a corresponding wireless network service. Since a seamless mobility service for maintaining a session is not provided while moving between heterogeneous networks, a user is required to access a desired wireless network again when the user frequently moves around heterogeneous networks. Further, an integrated security function for various wireless access networks is not provided.

### SUMMARY OF THE INVENTION

An embodiment of the present invention is directed to a client apparatus providing a mobility function and a security function between heterogeneous networks using a MOBIKE protocol, which provides one integrated media MODEM for accessing heterogeneous networks and enables a user to receive a wireless Internet service with service continuity while moving to heterogeneous networks and with security using an IPSec tunnel at the same time.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a client apparatus includes a wireless network access unit configured to access wireless networks; a security tunnel processor configured to establish a mobile security tunnel between a MOBIKE gateway and the client apparatus in the connected network, and to maintain the established mobile security tunnel when handover is performed in heterogeneous networks; and a mobile security tunnel controller configured to perform a MOBIKE protocol and to control a process of establishing and maintaining a mobile security tunnel of the security tunnel processor.

In accordance with another embodiment of the present invention, a client apparatus includes a mobile security tunnel unit configured to establish a mobile security tunnel between a MOBIKE gateway and the client apparatus; a MOBIKE unit configured to perform a MOBIKE protocol; a handover controller configured to control handover by establishing and managing a wireless network access policy; and a tunnel maintain unit configured to maintain the established mobile security tunnel when performing handover between heterogeneous networks.

In accordance with another embodiment of the present invention, a method for accessing a wireless network in user equipment supporting mobility and security between heterogeneous networks, comprising: fetching parameters for establishing connection to the wireless network; selecting a target wireless network among the heterogeneous networks based on the parameters and establishing connection to the selected target wireless network; initializing Internet Key Exchange (IKE) security association with a MOBIKE gateway using a MOBIKE protocol; and performing IKE authentication for establishing an IPSec tunnel with the MOBIKE gateway.

In accordance with another embodiment of the present invention, a method of establishing a security tunnel of a MOBIKE gateway for supporting mobility and security between heterogeneous networks in user equipment, comprising: initializing Internet Key Exchange (IKE) security association with the user equipment using a MOBIKE protocol; and performing IKE authentication for establishing an IPSec tunnel with the user equipment.

In accordance with another embodiment of the present invention, a handover method of user equipment supporting mobility and security between heterogeneous networks, comprising: monitoring Received Signal Strength (RSS) of a wireless network among the heterogeneous networks connected to the user equipment, wherein the user equipment establishes an IPSec tunnel to a MOBIKE gateway; establishing connection to a target wireless network for handover when the RSS is smaller than a predetermined threshold; and transmitting an INFORMATIONAL message to the MOBIKE gateway in order to inform the MOBIKE gateway that an IP address of the user equipment is changed due to handover.

In accordance with another embodiment of the present invention, a method of maintaining security association of a MOBIKE gateway for user equipment supporting mobility and security between heterogeneous networks, comprising: receiving an INFORMATIONAL message from the user equipment in order to inform that an IP address of the user equipment is changed due to handover, wherein the user equipment establishes an IPSec tunnel to the MOBIKE gateway; and transmitting an acknowledgement message for the information message.

### BRIEF DESCRIPTION OF THE DRAWINGS

FIG. 1 is a diagram illustrating a fundamental concept for providing mobility and security between heterogeneous networks using a MOBIKE protocol.

FIG. 2 is a diagram illustrating a MOBIKE signaling procedure where a client apparatus in accordance with an embodiment of the present invention is applied to.

FIG. 3 is a diagram illustrating a client apparatus for supporting mobility and security between heterogeneous networks using MOBIKE in accordance with an embodiment of the present invention.

FIG. 4 is a diagram illustrating a wireless access control block in a client apparatus in accordance with an embodiment of the present invention.

FIG. 5 is a detailed diagram illustrating an operating system region of a client apparatus in accordance with an embodiment of the present invention.

FIG. 6 is a diagram illustrating a user region of a client apparatus in accordance with an embodiment of the present invention.

FIG. 7 is a flowchart illustrating a wireless network access procedure in a client apparatus for supporting mobility and security between heterogeneous networks using MOBIKE in accordance with an embodiment of the present invention.

FIG. 8 is a flowchart illustrating a wireless connection release procedure in a client apparatus in accordance with an embodiment of the present invention.

FIG. 9 is a flowchart illustrating an automatic handover procedure between heterogeneous networks in a client apparatus in accordance with an embodiment of the present invention.

FIG. 10 is a flowchart illustrating a handover transition procedure in a client apparatus in accordance with an embodiment of the present invention.

FIG. 11 is a flowchart illustrating a method for automatic handover between heterogeneous networks in a client apparatus in accordance with an embodiment of the present invention.

FIGS. 12 and 13 are diagrams for illustrating a wireless network access process and a handover procedure in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

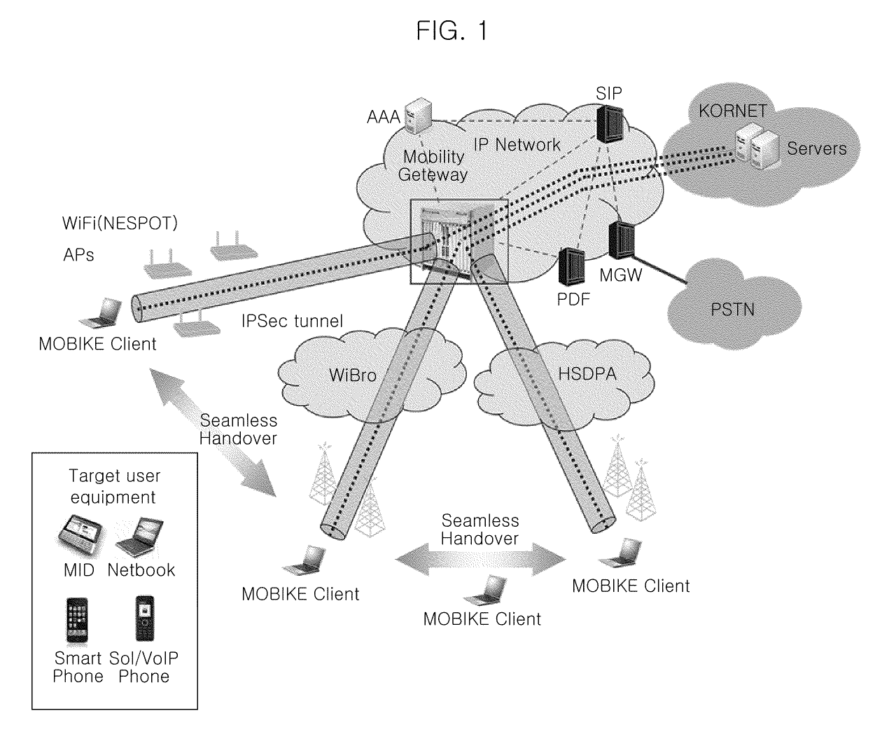

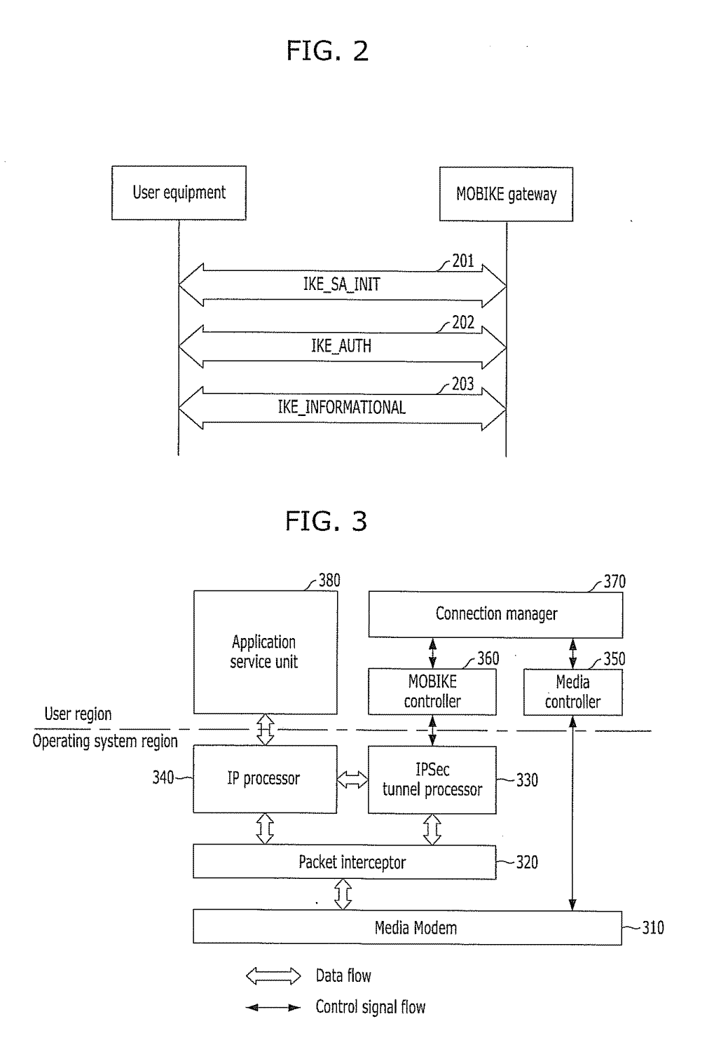

In order to clearly describe a client apparatus for supporting mobility and security between heterogeneous networks using a MOBIKE protocol in accordance with an embodiment of the present invention, related technologies will be described at first with reference to FIGS. 1 and 2.

Many researches have been actively made for developing technologies for providing an IF mobility function of mobile user equipment since 1990s. Such technologies for providing an IP mobility function of mobile user equipment have been developed in two directions. For example, the technologies are classified into a user equipment based IP mobility support technology and a network based IP mobility support technology. The technologies may be used for providing an IP mobility function between heterogeneous networks without modification.

The user equipment based IP mobility support technology is required to install a predetermined protocol stack or program at user equipment. For example, a client mobile IP (CHIP) technology [4, 5, 6] or a MOBIKE technology [1, 2] is widely known as the user equipment based IP mobility support technology.

The CHIP technology has been standardized into two directions: IPv4 (RFC 3344) and IPv6 (RFC 3775) as an Internet Engineering Task Force (IETF) standard. According to the CHIP technology, a home agent (HA) is installed to provide a mobility function, and a Care of Address (CoA) is assigned to each one of user equipment. The CHIP technology provide mobility through tunneling between a home agent (HA) and user equipment by managing states of a Home IP address (HoA), which is a real IP address, and a CoA according to movements of user equipment.

MOBIKE (IKEv2 Mobility and Multihomming: RFC 4555) is a protocol that improves a shortcoming of requiring new IKE connection when a user moves between networks at Internet Key Exchange (IKE) [7] for performing an IPSec protocol[3]. FIG. 2 shows a MOBKIE signaling procedure. MOBIKE is a technology for maintaining an IPSec tunnel with continuously using initial security setup parameters of an IP security protocol (IPSec) although a user moves between networks. As shown in FIG. 1, MOBIKE provides mobility and security between heterogeneous networks at the same time.

FIG. 1 is a diagram illustrating a fundamental concept for providing mobility and security between heterogeneous networks using a MOBIKE protocol.

As shown in FIG. 1, a mobility gateway supporting MOBIKE (MOBIKE gateway) is additionally installed at an access server of a core IP network, and a MOBIKE client program is installed at user equipment such as a mobile Internet device (MID), a notebook, a smart phone, and a SoIP/VoIP phone. When user equipment tries to access a wireless network, a client apparatus of the user equipment searches an optimal wireless network and tries to access the optimal wireless network. After user authentication, an IPSec tunnel is established between the MOBIKE gateway and the client apparatus. Then, the user equipment communicates with other user equipment or a server through the mobility gateway (MOBIKE gateway). Although the user equipment moves around various heterogeneous wireless networks after forming the IPSec tunnel, the IPSec tunnel can be continuously maintained through driving the MOBIKE protocol between the mobility gateway (MOBIKE gateway) and a user client program. Therefore, service continuity and security can be provided between heterogeneous wireless networks at the same time.

FIG. 2 is a diagram illustrating a MOBIKE signaling procedure where a client apparatus in accordance with an embodiment of the present invention is applied to.

At step S201, MOBIKE user equipment performs an IKE_SA_INIT procedure with a MOBIKE gateway. Here, IKE stands for Internet Key Exchange, SA stands for Security Association, and INIT denotes Initialization. That is, the MOBIKE user equipment performs a signaling procedure for acquiring Security Association (SA).

At step S202, the MOBIKE user equipment performs an IKE_AUTH procedure with the mobile security tunnel gateway after performing the IKE_SA_INIT procedure. Here, AUTH denotes Authentication. That is, the MOBIKE user equipment performs a signaling procedure for authenticating the Internet Key Exchange.

At step S203, the MOBIKE user equipment performs an IKE_INFORMATION procedure with the MOBIKE gateway after performing the IKE_AUTH procedure.

Meanwhile, a Proxy Mobile IP (PMIP: RFC 5213) [8] technology is one of representative network based IP mobility support technologies.

The standardization of PMIP has been progressed by Internet Engineering Task Force (IFTF). Recently, IETF compensates the defects of PMIP, such as a handover delay time, ineffective wireless resource usage, and requirement of additional client function at user equipment. Further, PMIP is a fundamental technology for realizing mobility between heterogeneous networks based on a service and handover policy and a user preference by providing independent interfaces of wireless access environments. The PMIP includes a Media Independent Handover (MIH) [9] and the device management (DM) of Open Mobile Alliance (OMA).

IP mobility between heterogeneous networks can be further effectively realized using the above mentioned IP mobility technologies.
[1] T. Kivinen, H. Tschofening, “Design of the IKEv2 Mobility and Multihoming (MOBIKE) Protocol”, IETF RFC 4621, August 2006
[2] P. Eronen, Ed., “IKEv2 Mobility and Multihoming Protocol(MOBIKE)”, IETF RFC 4555, June 2006
[3] Kent, S., R. Atkinson, “Security Architecture for the Internet Protocol”, IEFT RFC 2401, November 1998.
[4] C. Perkins, “IP Mobility Support”, IETF RFC 2002, October 1996.
[5] C. Perkins, “IP Mobility Support for IPv4”, IETF RFC 3344, August 2002
[6] D. Johnson, C. Perkins, J. Arkko, “Mobility

Support in IPv6”, IETF RFC 3775, June 2004
[7] C. kaufman, Ed., “Internet Key Exchange (IKEv2) Protocol”, IETF RFC 4306, December 2005
[8] S. Gundavelli, Ed., K. Leung, V. Devarapalli, K. Chowdhury, “Proxy Mobile IPv6”, IETF RFC 5213, August 2008
[9] IEEE 802.21, “Draft Standard for Local and Metropolitan Area Networks: Media Independent Handover Services”, December 2008.

Hereinafter, a client apparatus for supporting mobility and security between heterogeneous networks in accordance with an embodiment of the present invention will be described briefly.

The client apparatus in accordance with an embodiment of the present invention performs a mobility function and a security function between heterogeneous networks using a MOBIKE protocol by automatically recognizing a surrounding wireless network environment and accessing an optimal wireless network according to a user wireless access policy. Therefore, the client apparatus in accordance with an embodiment of the present invention does not require a user manually to select a predetermined wireless network. Further, in order to assure service continuity between the heterogeneous networks and a security service, the client apparatus in accordance with an embodiment of the present invention continuously maintains a previously established IPSec tunnel with initially created security association (SA) using the MOBIKE protocol although user equipment moves to heterogeneous networks.

For instance, the client apparatus in accordance with an embodiment of the present invention sets up a control message between each interface and a network device to provide mobility and security among a WiBro system, a 3G HSDPA system, and a WiFi system. That is, a virtual interface is created at user equipment, an address allocated by a network gateway is assigned to the virtual interface, and application service recognizes only an IP address of the virtual interface. Thus, the service continuity is assured although a real physical address is changed. Further, Received Signal Strength Indication (RSSI) of a wireless network having a highest user priority is regularly monitored. When the RSSI becomes higher or lower than a predetermined handover threshold, a handover procedure is carried out. As a handover procedure, a Make Before Break (MBB) soft handover procedure is used. The MBB soft handover procedure connects a new wireless network before releasing an existing network connection.

A user having user equipment with the client apparatus in accordance with an embodiment of the present invention may have a seamless and safe wireless Internet service according to a user wireless access policy without determining which network a user access. Here, the user wireless access policy may include a wireless network preference and a wireless network access priority.

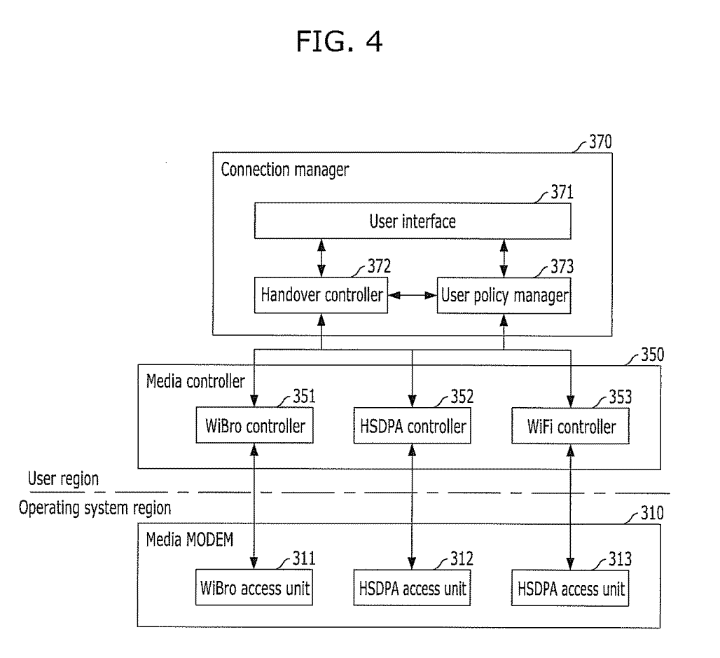

FIG. 3 is a diagram illustrating a client apparatus for supporting mobility and security between heterogeneous networks using MOBIKE in accordance with an embodiment of the present invention.

Throughout the specification, upload date denotes data uploaded from user equipment to a base station, and download data denotes data downloaded from a base station to user equipment.

As shown in FIG. 3, the client apparatus for supporting mobility and security between heterogeneous networks using MOBIKE in accordance with an embodiment of the present invention includes a media MODEM 310, a packet interceptor 320, an IPSec tunnel processor 330, an Internet protocol (IP) processor 340, a media controller 350, a MOBIKE controller 360, a connection manager 370, and an application service unit 380. The media MODEM 310 accesses a predetermined wireless network through a wireless link. The packet interceptor 320 analyzes upload data packets and download data packets. The IPSec tunnel processor 330 establishes an IPSec tunnel at an initial stage and maintains the initially established IPSec tunnel by cooperating with a MOBIKE controller 360 when performing handover between heterogeneous networks. The Internet protocol (IP) processor 340 processes an Internet protocol. The media controller 350 controls the media MODEM 310 to access a predetermined wireless network and to release existing connection to a predetermined wireless network. The MOBIKE controller 360 performs a MOBIKE protocol in response to the request of a connection manager 370 (CM) and controls the IPSec tunnel processor 330 to establish and to maintain an IPSec tunnel. The connection manager 370 manages MOBIKE information, requests the MOBIKE controller 360 to perform the MOBIKE protocol, and controls a handover procedure by establishing and managing a user wireless network access policy, and the application service unit 380 provides an application service by cooperating with the IP processor 340.

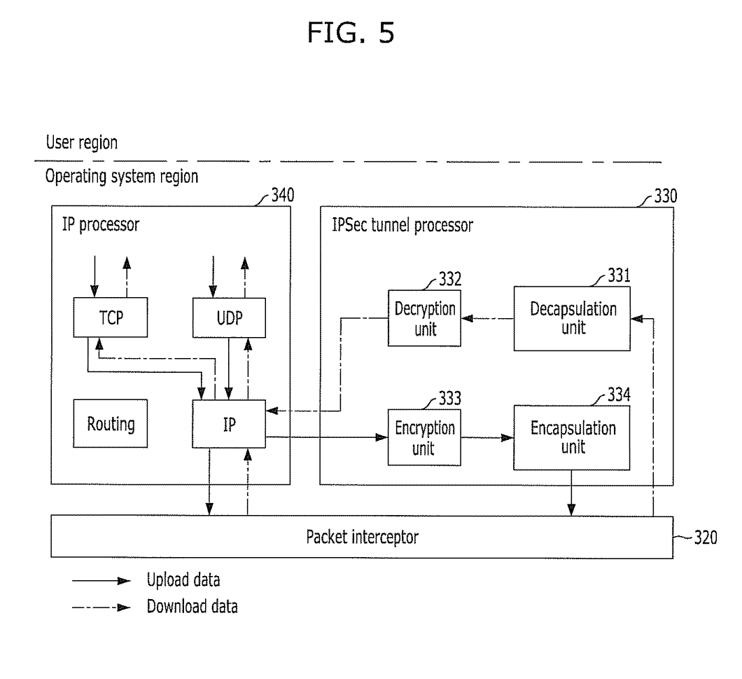

Hereinafter, the client apparatus for supporting mobility and security between heterogeneous networks using MOBIKE in accordance with an embodiment of the present invention will be described in detail with reference to FIGS. 4 to 6.

FIG. 4 is a diagram illustrating a wireless access control block in a client apparatus in accordance with an embodiment of the present invention.

As shown in FIG. 4, the wireless access control block of the client apparatus in accordance with an embodiment of the present invention includes the media MODEM 310, the media controller 350, and the connection manger 370.

The media MODEM 310 includes a WiBro access unit 311, a HSDPA access unit 312, and a WiFi access unit 313. The WiBro access unit 311 accesses a WiBro network and releases a corresponding wireless connection of the WiBro network in response to the control of the wireless network controller 350. The HSDPA access unit 312 accesses a 3^{rd} generation high speed downlink packet access (HSDPA) network and releases a corresponding wireless connection of the HSDPA network in response to the control of the wireless network controller 350. The WiFi access unit 313 accesses a WiFi network and releases a corresponding wireless connection of the WiFi network in response to the control of the wireless network controller 350.

The media controller 350 includes a WiBro controller 351 configured to control the WiBro access unit 311 to access a WiBro network and release a corresponding wireless connection thereof, a HSDPA controller 352 configured to control the HSDPA access unit 312 to access a HSDPA network and to release a corresponding wireless connection thereof, and a WiFi controller 353 configured to control the WiFi access unit 313 to access a WiFi network and to release a corresponding wireless connection.

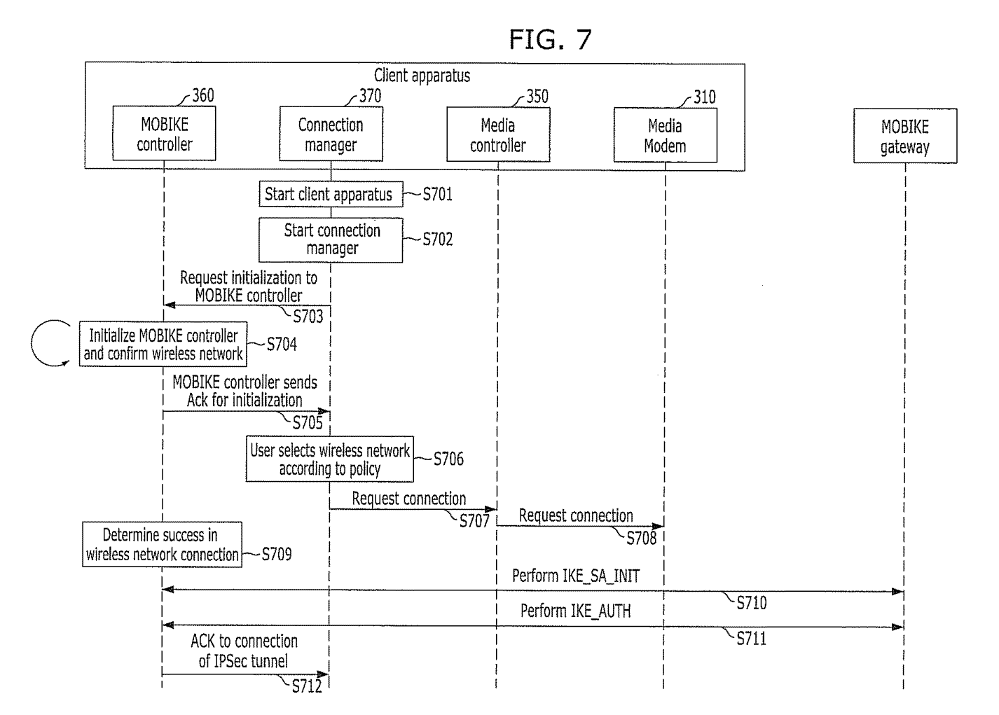

The connection manger 370 will be described in later with reference to FIG. 6.

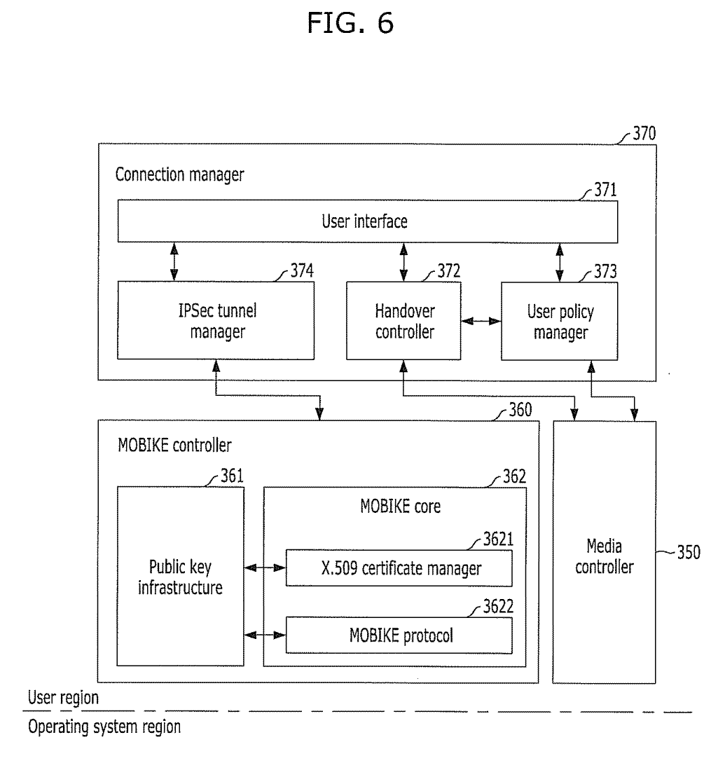

FIG. 5 is a detailed diagram illustrating an operating system region of a client apparatus in accordance with an embodiment of the present invention.

Referring to FIG. 5, the operating system region of the client apparatus in accordance with an embodiment of the present invention establishes and maintains an IPSec tunnel (mobile security tunnel). The operating system region additionally includes the packet interpreter 320 and the IPSec tunnel processor 330 at an existing Network Driver Interface Specification (NDIS) frame work environment for example the media MODEM and the IP processor.

The packet interceptor 320 intercepts downlink data packets received from one of a WiBro system, a WiFi system, and a 3G HSDPA system through the media MODEM 310 and determines whether the received downlink data packet is a packet to be encrypted to an IPSec tunnel or not. Then, the packet interceptor 320 transfers the downlink data packet to be encrypted to a decapsulation unit 331 of the IPSec tunnel processor 330. Further, the packet interceptor 320 transfers a downlink data packet not related to the IPSec tunnel to the IP processor 340. Here, the downlink data packet not related to the IPSec tunnel is a packet not to be encrypted. Accordingly, the application service unit 380 of the user region can directly process a corresponding data packet. Since the application service unit 380 is well-known technology, the detail description of the application service unit 380 is omitted.

The packet interceptor 320 transfers an uplink data packet from the IP processor 340 or the IPSec tunnel processor 330 to a corresponding wireless network through the media MODEM 310.

The IPSec tunnel processor 330 is an IPSec module. The IPSec tunnel processor 330 decapsulates a downlink data packet transferred from the packet interceptor 320 through the decapsulation unit 331, decodes the decapsulated packet through a decryption unit 332, and transfers the decrypted packet to the IP processor 340. Further, the IPSec tunnel processor 330 encrypts an uplink data packet from the IP processor 340 through an encryption unit 333, encapsulates the encrypted packet through an encapsulation unit 334, and transfers the encapsulated packet to the packet interceptor 320.

The IPSec tunnel processor 330 initially establishes an IPSec tunnel (mobile security tunnel) in response to the control of the MOBIKE controller 360 of the user region and maintains the initially established IPSec tunnel even after handover is performed between heterogeneous networks because a wireless network is changed. Therefore, the IPSec tunnel processor 330 assures service mobility and security at the same time.

FIG. 6 is a diagram illustrating a user region of a client apparatus in accordance with an embodiment of the present invention.

Referring to FIG. 6, the user region of the client apparatus in accordance with an embodiment of the present invention performs a function of establishing and maintaining an IPSec tunnel (mobile security tunnel). The user region additionally includes the media controller 350, the MOBIKE controller 360, and the connection manager 370 at an existing application service unit 380.

Since the media controller 350 was already described in detail with reference to FIG. 4, the media controller 350 will be described briefly in here.

The media controller 350 controls accessing a wireless network such as a WiBro system, a WiFi system. The media controller 350 also controls releasing corresponding wireless connection. The media controller 350 also transfers information related to a wireless network to the connection manager 370. Such information may be signal strength of a wireless access network.

The MOBIKE controller 360 is a MOBIKE module. The MOBIKE controller 360 performs a MOBIKE protocol in response to a request of the connection manager 370 and controls the IPSec tunnel processor 330 to establish an initial IPSec tunnel. The MOBIKE controller 360 also maintains the initially established IPSec tunnel by controlling the IPSec tunnel processor 330 even when handover is performed between heterogeneous networks in order to assure service continuity and security at the same time. The MOBIKE controller 360 shares information related to an IPSec tunnel with the connection manager 370.

The MOBIKE controller 360 includes a public key infrastructure 361 and a MOBIKE core 362.

The public key infrastructure 361 receives predetermined calculations necessary for the MOBIKE protocol from the MOBIKE core 362 and processes the received calculations, and transfers the result thereof to the MOBIKE core 362.

The MOBIKE core 362 includes a X.509 certificate manager 3621 and a MOBIKE protocol 3622. The MOBIKE core 362 performs a MOBIKE protocol and transfers related information to the connection manager 370. Further, the MOBKE core 362 controls the IPSec tunnel processor 330 of the operating system region.

The MOBIKE protocol 3622 performs a MOBIKE protocol itself and provides communication for a MOBIKE gateway, authentication, address allocation, and packet security.

The X.509 authentication certificate manager 3621 manages a certificate necessary for performing the MOBIKE protocol and allows the MOBIKE protocol 3622 to refer to the certificate when the MOBIKE protocol 3622 requests the certificate.

The connection manager 370 includes a user interface 371, a handover controller 372, a user policy manager 373, and an IPSec tunnel manager 374. The connection manager 370 provides an interface to a user, requests the MOBIKE controller 360 to perform the MOBIKE protocol by managing MOBIKE information, establishes and manages a user wireless network access policy, and controls handover between heterogeneous networks by managing handover decision information.

The user interface unit 371 displays a network state of a WiBro system, a 3^{rd} G HSDPA system, and a WiFi system, sets up system information related to the WiBro system, the 3^{rd} HSDPA system, and the WiFi system, stores and displays error logs of the WiBro system, the 3^{rd} HSPDA system, and the WiFi system, and displays error and event information by displaying a Tray Icon and a Balloon. The user interface unit 371 is also used to input/output operating thresholds related to a handover procedure.

The IPSec tunnel manager 374 sets up On/Off of MOBIKE, sets up a MOBIKE Debug mode, monitors state information related to MOBIKE and parameters, and provides the monitoring result to the MOBIKE controller 360.

The handover controller 372 manages a state of a wireless space for handover decision and controls handover between heterogeneous networks such as a WiBro system, a 3^{rd} Generation HSDPA system, and a WiFi system.

The user policy manager 373 sets up a corresponding wireless network to be used or not and sets up a connection priority. The user policy manager 373 also establishes and manages functions related to accessing wireless access networks. Further, the user policy manager 373 decides a handover priority.

As described above, the client apparatus in accordance with an embodiment of the present invention creates a communication protocol between user equipment and a MOBKIE IPSec Gateway (MIG), decides and establishes a wireless access policy. Therefore, the client apparatus in accordance with an embodiment of the present invention provides mobility and security between heterogeneous networks such as a WiBro system, a 3G HSDPA system, and a WiFi system to a user through one consistent wireless access environment.

Meanwhile, a handover procedure between heterogeneous wireless networks is classified into an automatic handover procedure and a manual handover procedure. In the automatic handover procedure, handover is performed according to a user priority. In the manual handover procedure, a user selects a target network to handover. In the automatic handover procedure, the 3G HSDPA system is assigned with the lowest priority because the 3G HSDPA system has the widest service coverage area and a higher access cost than that of the WiBro system and the WiFi system.

In the automatic handover procedure, a RSSI value of a currently connected wireless network is regularly calculated according to a user priority. The RSSI value may be calculated using an Exponentially Weighted Moving Average (EWMA) method as shown in Eq. 1 below. When a calculated RSSI value is higher or lower than a predetermined threshold, handover is performed to a new heterogeneous network. For example, the WiBro network may have an upper threshold value of 53 and a lower threshold value of 58. The WiFi network may have an upper threshold value of 50 and a lower threshold value of 60. When the WiFi network has a higher user priority than that of the WiBro network, the handover is performed to the WiBro network if the calculated RSSI value of the WiFi network becomes 60. If a calculated RSSI value of the WiBro network becomes higher than 58, the handover is performed again to the 3G HSDPA network which has the lowest priority. If a calculated RSSI value of the WiBro network becomes lower than 53 again, the handover is performed to the WiBro network again. If a calculated RSSI value of the WiFi network becomes lower than 50 again, the handover is performed to the WiFi network which has the highest priority. Here, the RSSI value is calculated using a weight and a previously calculated RSSI value. The newly calculated RSSI value is compared with a predetermined threshold to decide accessing a new wireless network. Therefore, the handover is not sensitively performed to the temporal change of the RSSI value. The handover is performed only when the RSSI value is continuously changed. The handover is performed sensitively as the weight becomes higher. On the contrary, the handover is performed insensitively as the weight becomes lower. Here, the RSSI stands for Received Signal Strength Indication. The weight may initially have a default value of 400. Also, the weight may have one of values from 0 to 1000.

$$\begin{matrix} Eq . 1 \\ RSSI = \frac{( \begin{matrix}1000 - \\ weight\end{matrix} ) \times previously calcualted RSSI + weight \times current RSSI}{1000}\end{matrix}$$

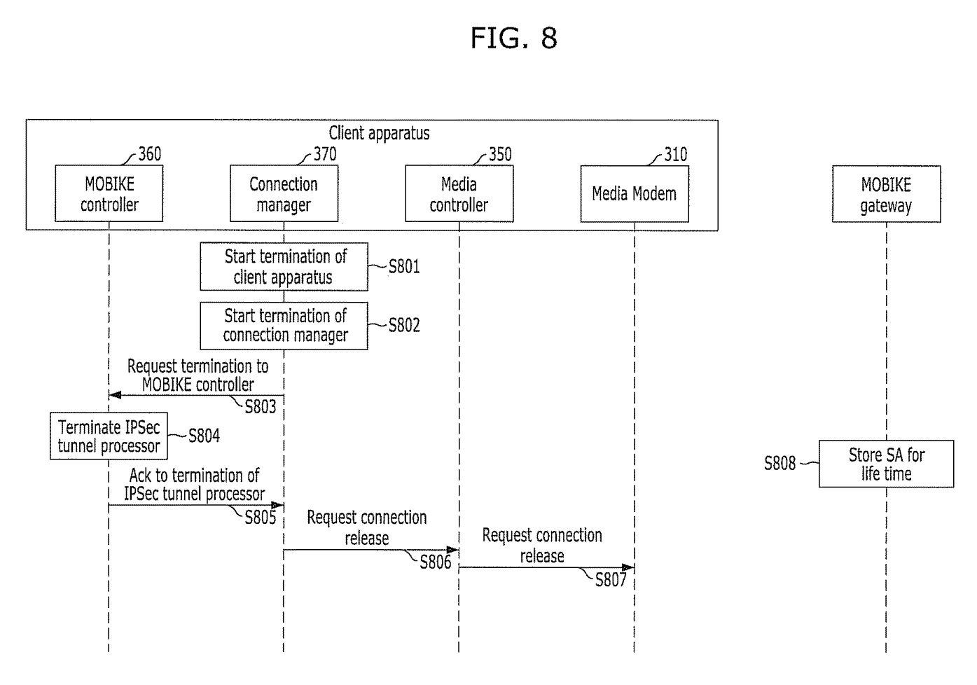

Hereinafter, a wireless network access procedure, a wireless network release procedure, and a handover procedure in a client apparatus for supporting service mobility and security between heterogeneous networks using a MOBIKE protocol in accordance with an embodiment of the present invention will be described with reference to FIGS. 7 to 11.

FIG. 7 is a flowchart illustrating a wireless network access procedure in a client apparatus for supporting mobility and security between heterogeneous networks using MOBIKE in accordance with an embodiment of the present invention.

At step S701, a client program begins at user equipment.

The connection manager 370 starts operating at step S702. For instance, the connection manager 370 releases an existing connection of a media MODEM and loads initial setup values required for operating MOBIKE.

The initial setup values may include a value denoting whether MOBIKE is supported or not, a value denoting whether automatic connection is performed or not when the connection manager 370 operates, a priority of each wireless access network, a MOBIKE gateway IP, a user equipment ID and password, upper and lower thresholds for handover between a WiBro system and a WiFi system, a Service Set identifier (SSID) of a WiFi system, a service ID and password thereof (for example: Nespot service), a recognition and model number of a 3G HSDPA system, a value denoting whether Authentication Header/Encapsulating security payload (AH/ESP) of IPSec is supported or not, and a value denoting whether a log file is stored or not.

At step S703, the connection manager 370 requests the MOBIKE controller 360 to be initialized.

At step S704, the MOBIKE controller 360 performs initialization and checks available wireless networks to be connected at step S704.

At step S705, the MOBIKE controller 360 sends acknowledgement of the initialization request to the connection manager 370.

At step of S706, the connection manager 370 selects a wireless network to be accessed according to a user policy such as a user wireless network access policy.

At step of S707, the connection manager 370 requests the media controller 350 to establish connection to an optimal wireless network among the available wireless network.

At step S708, the media controller 350 requests the media MODEM 310 to establish connection to a corresponding optimal wireless network.

At step S709, the MOBIKE controller 360 confirms whether the optimal wireless network is successfully connected or not through the connection manager 370.

At step S710, the MOBIKE controller 360 performs an IKE_SA_INIT procedure, which is a MOBIEK signaling procedure between the client apparatus and a MOBIKE gateway. For instance, the MOBIKE controller 360 performs a signaling procedure for acquiring security association (SA) with the MOBIKE gateway.

After the IKE_SA_INIT procedure, the MOBIKE controller 360 performs an IKE_AUTH procedure at step S711. The Internet Key Authentication (IKE_AUTH) procedure is a MOBIKE signaling procedure between the client apparatus with the MOBIKE gateway. Then, the MOBIKE gateway forms an IPSec tunnel using an IP allocated to the user equipment. Finally, the user equipment is connected to a desired wireless network using MOBIKE.

At step S712, the MOBIKE controller 360 informs the connection manager 370 that the user equipment is connected to the desired wireless network through the IPSec tunnel.

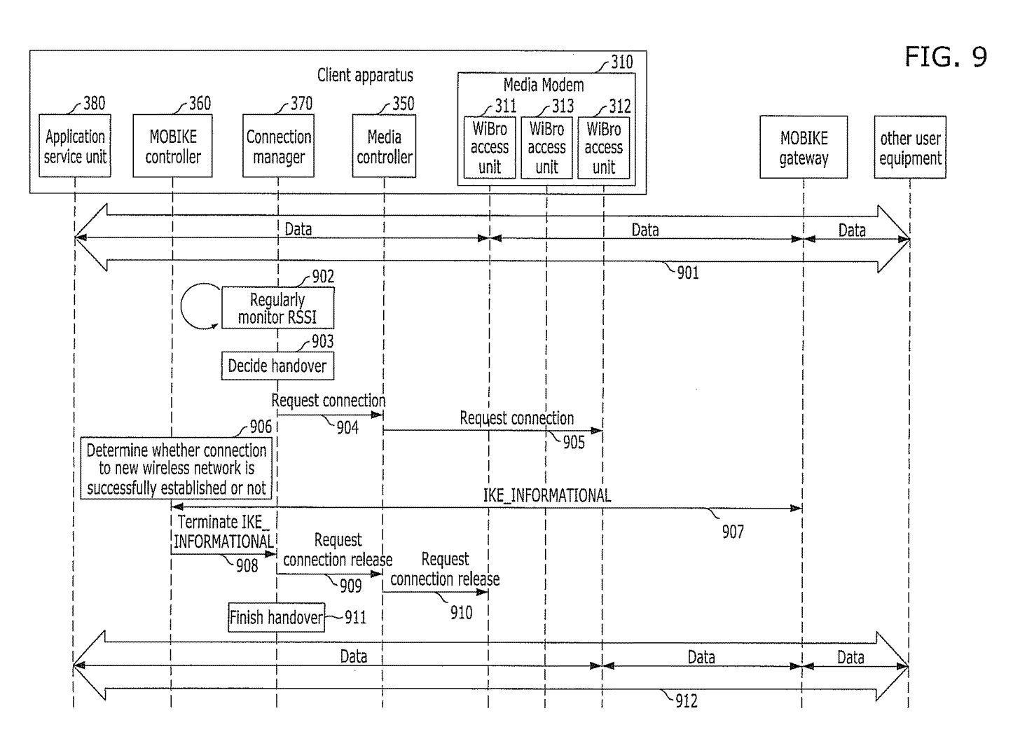

FIG. 8 is a flowchart illustrating a wireless connection release procedure in a client apparatus in accordance with an embodiment of the present invention.

At step S801, the user equipment starts a client program termination procedure.

At step S802, the connection manager 370 starts a termination procedure.

At step S803, the connection manager 370 requests a termination procedure to the MOBIKE controller 360.

At step S804, the MOBIKE controller 360 performs the termination procedure after receiving the termination request from the connection manager 370.

Meanwhile, the MOBIKE gateway maintains information related to the security association (SA) established during the IKE_SA_INIT procedure for a predetermined life time at step S808.

At step S805, the MOBIKE controller 360 transfers an acknowledgement for the request of the termination procedure to the connection manager 370.

At step S806, the connection manager 370 transfers a release request to the media controller 350 for releasing connection to the currently connected media MODEM after receiving the acknowledgement from the MOBIKE controller 360.

At step S807, the media controller 350 transfers the release request to the media MODEM 370 and the media MODEM 370 performs a related procedure for releasing the currently established connection.

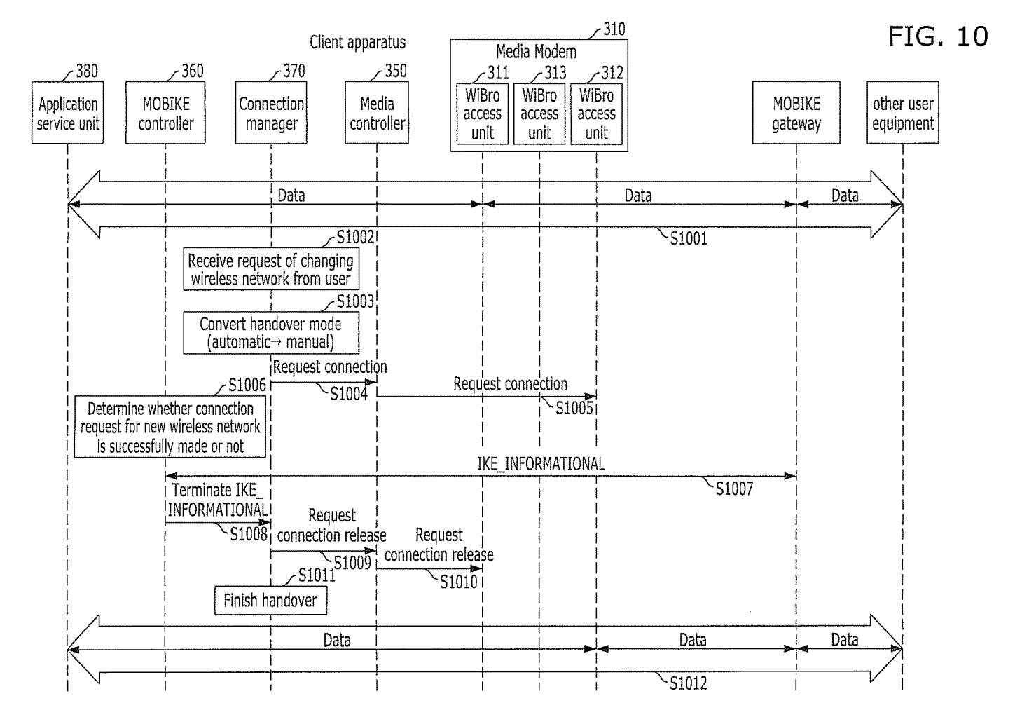

FIG. 9 is a flowchart illustrating an automatic handover procedure between heterogeneous networks in a client apparatus in accordance with an embodiment of the present invention. FIG. 9 shows an automatic handover procedure from a WiBro network to a HSDPA network for convenience.

At step S901, the client apparatus of user equipment receives/transmits user traffic from/to other user equipment through a WiBro network. Particularly, the client apparatus accesses the WiBro network through the WiBro access unit 311 in the media MODEM 370 and transmits/receives user traffic to/from the other equipment through the WiBro network.

At step S902, the connection manager 370 checks handover decision parameters for preparing a handover procedure. For instance, the connection manager 370 regularly checks the Received Signal Strength Indication (RSSI) of a media MODEM according to a user policy to prepare the handover procedure. Here, the user policy may be a user wireless network access policy.

For example, the automatic handover procedure may be performed according to a wireless network access policy having a user preference order of a WiFi system, a WiBro system, and a 3G HSDPA system based on a RSSI value. In this case, the connection manager 370 regularly checks the RSSI of a media MODEM for the WiFi system and the WiBro system. For the 3G HSPDA system, the connection manager 370 determines whether it is possible to connect the 3G HSPDA network or not without checking the RSSI thereof because the user preference order of the 3G HSPDA system is the lowest and a service coverage area thereof is wide.

At step S903, the connection manager 370 regularly monitors a handover threshold of a connected wireless network and handover thresholds of wireless networks having higher priorities than that of the connected wireless network and decides handover according to the monitoring result.

When the handover threshold of the connected wireless network becomes lower than the predetermined handover threshold, the connection manager 370 decides handover to a wireless network having a next highest priority.

When a handover threshold of a wireless network having a higher priority than the connected wireless network is restored and becomes higher than the predetermined handover threshold, the connection manager 370 decides handover to the wireless network having the higher priority.

At step S904, the connection manager 370 requests the media controller 350 to establish a wireless connection to the target wireless network. That is, the connection manager 370 requests the media MODEM to establish connection to the target wireless network.

At step S905, the media controller 350 transfers a connection request signal to the media MODEM 310 and a corresponding wireless access unit such as the HSDPA access unit 313 performs a wireless network connection procedure.

After the HSDPA access unit 312 completely performs the wireless network connection procedure, the MOBIKE controller 360 determines whether the wireless connection is successfully established or not through the connection manager 370 and confirms an IP and a MOBIKE gateway at step S906.

At step S907, the MOBIKE controller 360 updates Security Association (SA) information by exchanging Internet Key information (IKE_INFORMAITION) with a MOBIKE gateway through the media MODEM newly establishing connection to the target wireless network.

At step S908, the MOBIKE controller 360 transfers an IKE_INFORM termination signal to the connection manager 370.

The connection manager 370 requests the media controller 350 to release a previously established connection of a media MODEM, for example, a wireless network connection of the WiBro access unit, at step S909.

Then, the media controller 350 transfers the release request signal to the WiBro access unit with reference to the release request signal from the connection manager 370 at step S910.

At step S911, the connection manager 370 performs a connection release procedure for releasing the previously established connection of the media MODEM, for example, the WiBro access unit and finishes the handover procedure.

After updating the SA information and finishing the handover procedure, user traffic is transmitted or received through a new medium MODEM, for example, a HSDPA access unit.

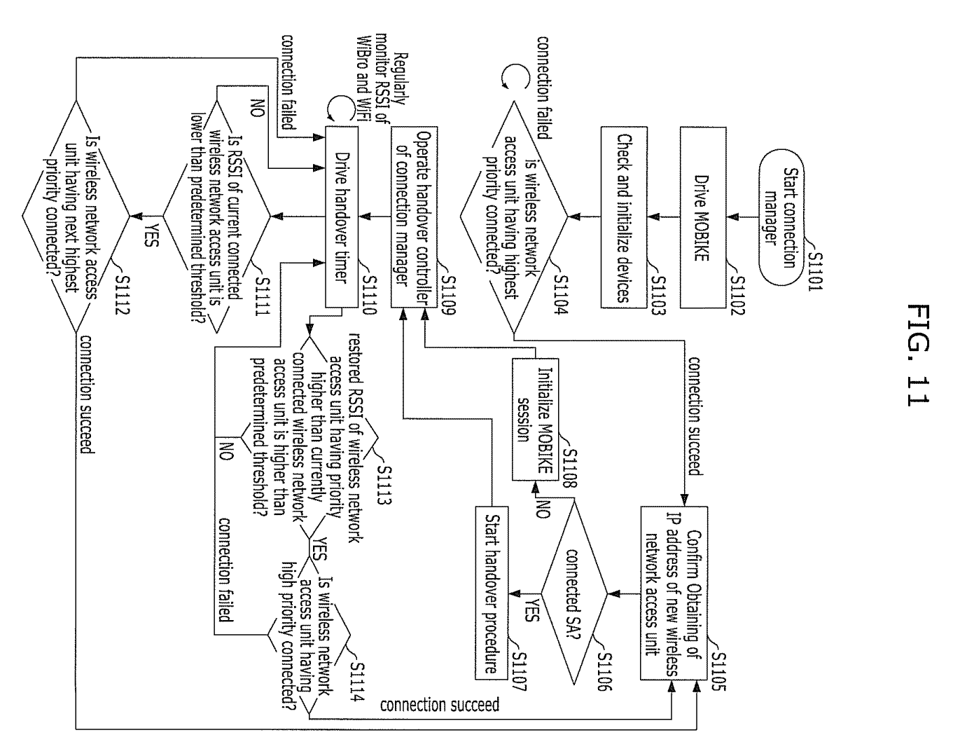

FIG. 10 is a flowchart illustrating a handover transition procedure in a client apparatus in accordance with an embodiment of the present invention. Particularly, FIG. 10 shows a procedure for transiting an automatic handover procedure to a manual handover procedure.

At first, the client apparatus of user equipment is transmitting/receiving user traffic to/from other user equipment at step S1001. That is, the client apparatus accesses a WiBro network through the WiBro access unit 311 of the media MODEM 370 and transmits/receives user traffic to/from other user equipment through the WiBro network.

The connection manager 370 is in an automatic handover mode that can perform an automatic handover procedure after checking a handover decision parameter. That is, the connection manager 370 regularly monitors Received Signal Strength Indication of a media MODEM according to a user policy and performs handover automatically based on the monitoring result.

At step S1002, the connection manager 370 is requested to forcedly convert the automatic handover mode to a manual handover mode by a user through a user interface 371 and receives a user selected wireless network to be connected.

At step S1003, the connection manager 370 converts the automatic handover mode to the manual handover mode in response to the user request.

At step S1004, the connection manager 370 requests the media controller 350 to control a corresponding access unit of a media MODEM to establish connection to the user selected wireless network.

The media controller 350 controls the corresponding access unit of a media MODEM, for example the HSDPA access unit to establish a wireless connection to a 3G HSDPA network by transferring a connection request signal to the corresponding access unit of the media MODEM at step S1005.

After the media MODEM establishes the wireless connection, the MOBIKE controller 360 confirms whether the wireless connection is successfully established or not through the connection manager 370 and checks an IP and a MOBIKE gateway at step S1006.

At step S1007, the MOBIKE controller 360 updates security association (SA) information by exchanging the IKE_INFORMATION with the MOBIKE gateway through the newly established wireless connection of the media MODEM.

At step S1008, the MOBIEK controller 360 transfers an IKE INFORMATION termination signal to the connection manager 370.

The connection manager 370 requests the media controller 350 to release a previously established connection of a media MODEM, for example a previously established connection of a WiBro access unit, at step S1009.

The media controller 350 transfers the connection release request to the WiBro access unit with reference to a connection release request from the connection manager 370 and the WiBro access unit release the previously established connection at step S1010.

At step S1011, the connection manager 370 performs the connection release procedure to release the previously established connection of the WiBro access unit and finishes the handover procedure.

After updating the SA information and finishing the handover procedure, the user traffic is transmitted or received through a newly established connection of a media MODEM such as the connection of the HSDPA access unit.

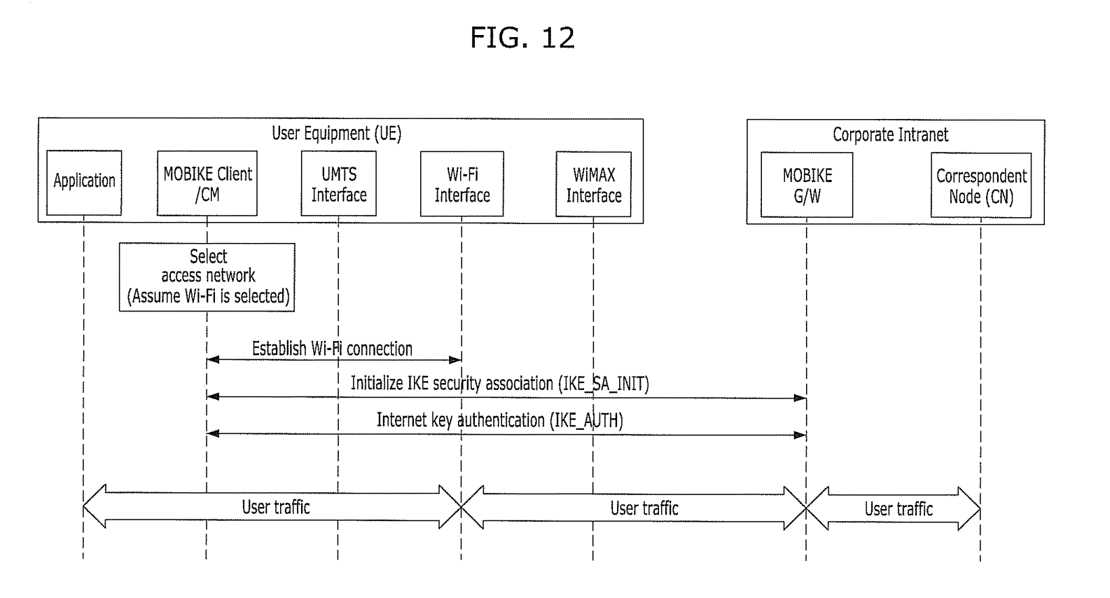

FIG. 11 is a flowchart illustrating a method for automatic handover between heterogeneous networks in a client apparatus in accordance with an embodiment of the present invention.

At step S1101, the connection manager 370 starts operating. At step S1102, the connection manager 370 drives MOBIKE.

At step S1103, the client apparatus checks whether devices such as wireless network access units of a media MODEM are properly installed or not and initializes the devices.

At step S1104, the client apparatus tries to connect a wireless network access unit of an available wireless network having the highest priority in a media MODEM and determines whether connection is successfully established or not.

If the connection is failed at step S1104, the client apparatus continuously tries to connect the wireless network access unit having the highest priority. After the connection is successfully established, the client apparatus acquires an IP address of a new wireless network access unit of the media MODEM at step S1105. If it is failed to connect to the wireless network access unit having the highest priority in the media MODEM, the client apparatus may determine whether other wireless network access unit having the next highest priority in the media MODEM is connected or not by trying to connect the other wireless network access unit at step S1112.

The client apparatus determines whether there is security association (SA) established at step S1106. If there is the SA established, the client apparatus maintains the SA and starts a handover procedure at step S1107. If not, the client apparatus initializes a MOBIKE session at step S1108. That is, new security association (SA) is established.

Accordingly, a handover controller 372 of the connection manager 370 starts operating at step S1109 and a handover timer operates at step S1110. The client apparatus regularly monitors a Received Signal Strength Indication (RSSI) of a media MODEM and prepares a handover procedure based on the monitoring result. For example, the client apparatus regularly monitors RRSIs of corresponding wireless network access units in a media MODEM for a WiFi system and a WiBro system and prepares a handover procedure based on the monitoring result. However, the client apparatus determines whether it is possible to connect a HSDPA network or not without monitoring the RSSI of a corresponding wireless access unit of the HSDPA network in a media MODEM to prepare the handover procedure.

The client apparatus decides a handover procedure to be performed by regularly monitoring a handover threshold of a currently connected wireless network access unit in a media MODEM and handover thresholds of wireless network access units having priorities higher than that of the currently connected wireless access unit in a media medium at steps S1111 to S1114.

That is, the MOBIKE client apparatus determines whether a RSSI value of a currently connected wireless network access unit is lower than a predetermined handover threshold at step S1111. If the RSSI value is not lower than the predetermined handover threshold, the client apparatus regularly monitors the RSSI value at step S1110. If the RSSI value is lower than the predetermined handover threshold, the client apparatus determines whether a wireless access unit having a next highest priority is connected or not by trying to connect the wireless network access unit having the next highest priority at step S1112.

If it is failed to connect to the wireless network access unit having the next highest priority at step S1112, the client apparatus regularly monitors a handover decision parameter at step S1110. If the connection is successfully established to the wireless network access unit having the next highest priority, the client apparatus acquires an IP address of a newly connected wireless network access unit in a media MODEM at step S1105.

Meanwhile, the client apparatus checks whether or not a RSSI value of a wireless network access unit having a priority higher than a currently connected wireless network access unit is restored and becomes higher than the predetermined threshold at step S1113. If not, the client apparatus performs the step S1110 of regularly monitoring the handover decision parameter. If the RSSI value is restored and becomes higher than the predetermined threshold, the client apparatus determines whether the wireless network access unit having a priority higher than a currently connected wireless network access unit is connected or not by trying to connect the wireless network access unit having a priority higher than a currently connected wireless network access unit at step S1114.

If it is failed at step S1114, the client apparatus performs the step S1110 of regularly monitoring the handover decision parameter. If it is succeed, the client apparatus performs the step S1105 of acquiring an IP address of the newly connected wireless network access unit in a media MODEM.

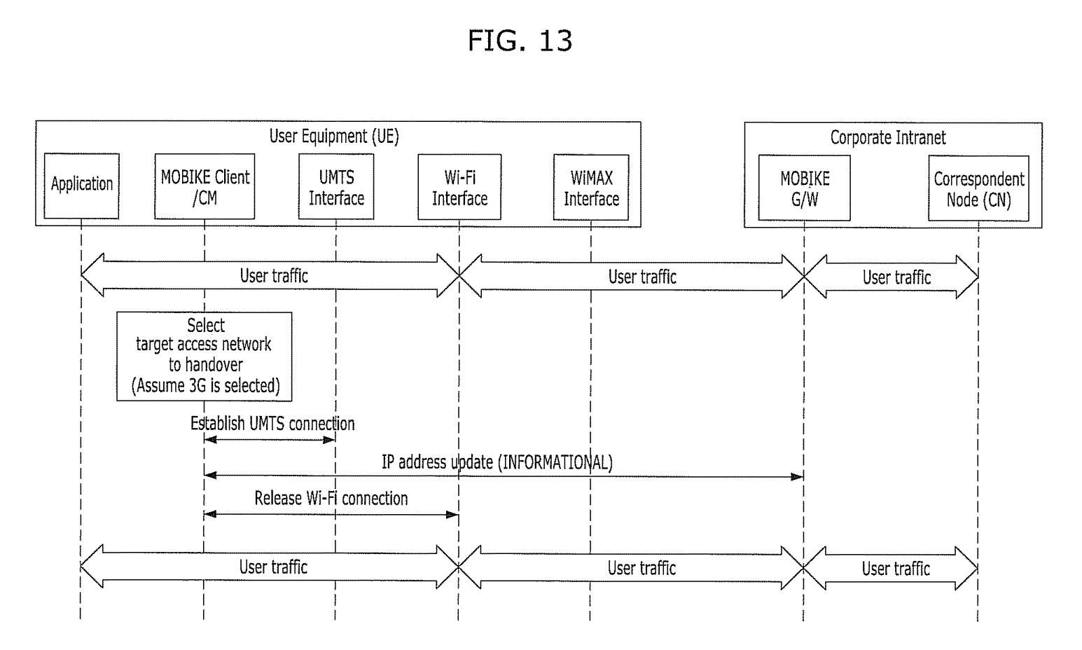

FIGS. 12 and 13 are diagrams for illustrating a wireless network access process and a handover procedure in accordance with another embodiment of the present invention. FIG. 12 is a generalized diagram of a wireless network access procedure shown in FIG. 7, and FIG. 13 is a generalized diagram of a handover procedure shown in FIG. 9.

As shown in FIGS. 12 and 13, application corresponds to the application service unit 380. MOBIKE client corresponds to the MOBIKE controller 360, and CM corresponds to the connection manager 370. A UMTS interface, a Wi-Fi interface, and a Wi MAX interface correspond to the HSDPA access unit 312, the Wi-Fi access unit 313, and the WiBro access unit 311, respectively.

At first, FIG. 12 will be described before describing FIG. 13. FIG. 12 shows a method of accessing a WiFi network from user equipment. The user equipment corresponds to a client apparatus.

The connection manager fetches parameters to establish connection. Here, the parameters may include at least one of information on user's preferences for wireless networks, an IP address of a MOBIKE gateway, and a predetermined RSS(Received Signal Strength) threshold value for handover. The connection manager selects an access network based on the parameters and establishes connection to the selected access network. When the connection to the WiFi network is established, the MOBIKE client initiates a security association (SA) procedure with the MOBIKE gateway. The MOBIKE client and the MOBIKE gateway perform an IKE_SA_INIT procedure for initializing Internet Key Security Association and perform an IKE_AUTH procedure to set up an IPSec tunnel. After the IPSec tunnel is established between the MOBIKE client and the MOBIKE gateway, the MOBIKE client informs the connection manager of the completion of the wireless network access. Then, a user can transmit and receive data through the accessed network.

FIG. 13 is a diagram illustrating a method for handover from a WiFi network to a UMTS network in accordance with an embodiment of the present invention.

The MOBIKE gateway monitors RSSI from a WiFi access point (AP) while user equipment is connected to the WiFi network. If the monitored RSS value becomes smaller than a predetermined threshold, user equipment may handover to other wireless network. After the user equipment decides to handover, the connection manager establishes connection a target access network to handover and the MOBIKE client transmits an INFORMATIONAL(IKE_INFORMATIONAL) message to the MOBIEK gateway in order to inform that the IP address of the user equipment is changed. After exchanging the INFORMATIONAL message, user data traffic is transmitted and received through the target wireless network. The connection manager releases the connection to the WiFi network. When the user equipment handovers, the MOBIKE gateway maintains security access of the user equipment.

In a client apparatus for supporting mobility and security between heterogeneous networks using a MOBIKE protocol in accordance with an embodiment of the present invention, an integrated media Modem for accessing heterogeneous networks may be provided to a user. The user may be provided with a wireless Internet service with service continuity while moving between heterogeneous networks and with security using an IP security protocol (IPSec) tunnel.

The client apparatus in accordance with an embodiment of the present invention does not require a user to select a predetermined wireless network. The client apparatus in accordance with an embodiment of the present invention automatically recognizes a surrounding wireless environment and accesses an optimal wireless network according to a user wireless network access policy. Therefore, the client apparatus in accordance with an embodiment of the present invention may expands the use of wireless infra, provide a consistent wireless network access environment to a user in various wireless environments, and create a new business model of a mobile intranet service and a wireless Internet service for vehicle in moving by providing service continuity and security between heterogeneous networks.

The client apparatus for supporting mobility and security between heterogeneous networks using a MOBIKE protocol in accordance with an embodiment of the present invention may be used for code division multiple access (CDMA), wide-CDMA (WCDMA), high speed downlink packet access (HSDPA), and high speed uplink packet access (HSUPA) based wireless networks (for example, mobile communication network), a complex Pi-sigma network (CPSN) (for example, a satellite communication network), an IEEE 802.11x based wireless communication network (for example, a wireless LAN communication network), an IEEE 802.16x based wireless communication network (for example, mobile Internet), and an orthogonal frequency division multiplexing access (OFDMA) based 3^{rd} generation partnership project long term evolution (3GPP LTE) based wireless communication network.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A client apparatus comprising:
a wireless network access unit configured to access wireless networks;
a security tunnel processor configured to establish a mobile security tunnel between a MOBIKE gateway and the client apparatus in the connected network, and to maintain the established mobile security tunnel when handover is performed in heterogeneous networks; and
a mobile security tunnel controller configured to perform a MOBIKE protocol and to control a process of establishing and maintaining a mobile security tunnel of the security tunnel processor.

2. The client apparatus of claim 1, further comprising a packet analysis unit configured to analyze uplink and downlink data packets,
wherein the security tunnel processor decapsulates a downlink data packet from the packet analysis unit, decrypts the decapsulated data packet, and transfers the decrypted packet to an Internet protocol processor,
the security tunnel processor encrypts a uplink data packet from the Internet protocol processor, encapsulates the encrypted data packet, and transfers the encapsulated packet to the packet analysis unit,
the security tunnel processor establishes an initial IP security protocol (IPSec) tunnel as the mobile security tunnel in response to control of the mobile security tunnel controller, and
the security tunnel processor maintains the established initial IPSec tunnel during handover between heterogeneous networks.

3. The client apparatus of claim 2, wherein the packet analysis unit intercepts a downlink data packet from the wireless network access unit, analyzes whether the intercept data packet is required to be encrypted to an IPSec tunnel, transfers a downlink data packet to be encrypted to the security tunnel processor, and transfers a downlink data packet not related to a security tunnel to the Internet protocol processor, and
the packet analysis unit transfers a uplink data packet from the Internet protocol processor or the security tunnel processor to the wireless network access unit.

4. The client apparatus of claim 1, further comprising a wireless network controller configured to control a wireless network accessing process and a connection releasing process of the wireless network access unit,
wherein the wireless network controller transfers Received Signal Strength Indication (RSSI) information of each one of the wireless networks to a wireless network connection manager.

5. The client apparatus of claim 4, further comprising the wireless network connection manager configured to request the mobile security tunnel controller to perform a MOBIKE protocol by managing MOBIKE information and to control handover by setting up and managing a wireless network access policy,
wherein the mobile security tunnel controller performs a MOBIKE protocol in response to a request of the wireless network connection manager, instructs the security tunnel processor to establishes an initial IPSec tunnel, controls the security tunnel processor to maintain the established initial IPSec tunnel, and shores information related to an IPSec tunnel with the wireless network connection manager.

6. The client apparatus of claim 5, wherein the mobile security tunnel controller comprises:
a mobile security tunnel core configured to transfer MOBIKE information to the wireless network connection manager by performing a MOBIKE protocol in response to a request of the wireless network connection manager and to control the security tunnel processor; and
a public key infrastructure configured to perform encryption calculation necessary for a MOBIKE protocol in response to a request of the mobile security tunnel core.

7. The client apparatus of claim 6, wherein the mobile tunnel core comprises:
a MOBIKE protocol configured to perform a MOBIKE protocol, to perform an authenticate process and an address allocation process with the MOBIKE gateway, and to provide communication for packet security; and
a x.509 certificate manager configured to manage certificates for performing the MOBIKE protocol and to allow the MOIBKE protocol to refer the certificates in response to a request of the MOBIKE protocol.

8. The client apparatus of claim 5, wherein the wireless network connection manager comprises:
a user interface configured to provide an interface to a user;
a mobile security tunnel manager configured to set up ON/OFF of MOBIKE, to set up whether a MOBIKE debug mode is operated or not, to monitor MOBIKE related state information and parameters, and to transfer the monitoring result to the mobile security tunnel controller;
a handover controller configured to manage a wireless space state for handover decision and to control handover between heterogeneous networks; and
a user policy manager configured to decide a handover priority according to a wireless network access policy of the user.

9. The client apparatus of claim 5, wherein the wireless network connection manager regularly calculates a RRSI value using an Exponentially Weighted Moving Average (EWMA) method using an Equation:
$$RSSI = \frac{( \begin{matrix}1000 - \\ weight\end{matrix} ) \times previously calcualted RSSI + weight \times current RSSI}{1000} ,$$
and decides handover by comparing the calculated RSSI with a predetermined threshold.

10. A client apparatus comprising:
a mobile security tunnel unit configured to establish a mobile security tunnel between a MOBIKE gateway and the client apparatus;
a MOBIKE unit configured to perform a MOBIKE protocol;
a handover controller configured to control handover by establishing and managing a wireless network access policy; and
a tunnel maintain unit configured to maintain the established mobile security tunnel when performing handover between heterogeneous networks.

11. The client apparatus of claim 10, wherein the mobile security tunnel is an IP security protocol (IPSec) tunnel.

12. The client apparatus of claim 10, wherein the client apparatus accesses a first wireless network through a mobile security tunnel using MOBIKE, prepares handover by checking handover decision parameters, decides handover by monitoring handover thresholds, obtains an IP address by access a second wireless network, updates security association (SA) information, and finishes handover by releasing connection to the first wireless network.

13. The client apparatus of claim 10, wherein the client apparatus accesses a first wireless network through a mobile security tunnel using MOBIKE, is requested to convert an automatic handover mode to a manual handover mode through a user interface, receives a second wireless network as a target access network through the user interface, converts a handover method from the automatic handover mode to the manual handover mode, obtains an IP address by accessing the second wireless network, updates security association (SA) information, and finishes handover by releasing connection to the first wireless network.

14. A method for accessing a wireless network in user equipment supporting mobility and security between heterogeneous networks, comprising:
fetching parameters for establishing connection to the wireless network;
selecting a target wireless network among the heterogeneous networks based on the parameters and establishing connection to the selected target wireless network;
initializing Internet Key Exchange (IKE) security association with a MOBIKE gateway using a MOBIKE protocol; and
performing IKE authentication for establishing an IPSec tunnel with the MOBIKE gateway.

15. The method of claim 14, wherein the parameters include at least one of user's preference information for a wireless network, an IP address of the MOBIKE gateway, predetermined Received Signal Strength (RSS) information for handover.

16. The method of claim 14, wherein said fetching parameters and said establishing connection to the selected target wireless network are performed by a connection manager of the user equipment, and
said initializing a MOBIKE gateway and said performing IKE authentication are performed by a MOBIKE client of the user equipment.

17. A method of establishing a security tunnel of a MOBIKE gateway for supporting mobility and security between heterogeneous networks in user equipment, comprising:
initializing Internet Key Exchange (IKE) security association with the user equipment using a MOBIKE protocol; and
performing IKE authentication for establishing an IPSec tunnel with the user equipment.

18. A handover method of user equipment supporting mobility and security between heterogeneous networks, comprising:
monitoring Received Signal Strength (RSS) of a wireless network among the heterogeneous networks connected to the user equipment, wherein the user equipment establishes an IPSec tunnel to a MOBIKE gateway;
establishing connection to a target wireless network for handover when the RSS is smaller than a predetermined threshold; and
transmitting an INFORMATIONAL message to the MOBIKE gateway in order to inform the MOBIKE gateway that an IP address of the user equipment is changed due to handover.

19. The handover method of claim 1B, wherein said monitoring Received Signal Strength (RSS) and said establishing connection to a target wireless network are performed by a connection manager of the user equipment, and
said transmitting an INFORMATIONAL message is performed by a MOBIKE client of the user equipment.

20. A method of maintaining security association of a MOBIKE gateway for user equipment supporting mobility and security between heterogeneous networks, comprising:
receiving an INFORMATIONAL message from the user equipment in order to inform that an IP address of the user equipment is changed due to handover, wherein the user equipment establishes an IPSec tunnel to the MOBIKE gateway; and
transmitting an acknowledgement message for the information message.
